(19) United States
(12) Patent Application Publication
(10) Pub. No.: US 2006/0061253 A1
(43) Pub. Date: Mar. 23, 2006

(54) Picture display device

(75) Inventors: Ramon Pascal Van Gorkom, Eindhoven (DE); Siebe Tjerk De Zwart, Eindhoven (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/531,606

(22) PCT Filed: Sep. 15, 2003
(86) PCT No.: PCT/IB03/04027

§ 371 Date: Apr. 14, 2005

(30) Foreign Application Priority Data
Oct. 18, 2002 (EP) 02079340.2

(51) Int. Cl. H01J 1/62; H01J 63/04

(52) U.S. Cl. 313/495; 313/497

(57) ABSTRACT

A display device (1) comprises a luminescent display screen (15), and means for directing electrons towards the display screen (15). Said means comprises comprise an arrangement of at least three plates (36, 41, 42), with a middle plate (36) having selection apertures, and selection electrodes associated with the selection apertures. The selection apertures, the selection electrodes and the plates are arranged for having the electron currents, on their way from a source to the electroluminescent screen, selectively pass the apertures in the middle plate and alternately run at opposite sides of the middle plate. An anti-leakage layer (44 eg) for providing in operation a tunneling counteracting potential is provided on a plate of the arrangement to prevent leakage electrons through gaps between the middle plate and an adjacent plate.

This invention relates to a display device comprising a vacuum envelope an inner side of which is provided with an luminescent display screen, said vacuum envelope comprising at least an electron source and means for directing electrons towards the display screen, said means comprising an arrangement of branched electron ducts, the display device comprising an arrangement of at least three plates, comprising a middle plate having selection apertures, and selection electrodes associated with the selection apertures for application of selection voltages, the selection aperture, the selection electrodes and the plates arranged for having the electron currents on their way from the source to the electroluminescent screen selectively pass the apertures in the middle plate and alternately run at opposite sides of the middle plate.

An embodiment of such a display device is known from U.S. Pat. No. 5,781,166. In the known display device, electron transport between the electron source (for example a wire cathode) and the cathode-luminescent screen takes place by means of electron transport ducts. Electrons are transported from an entrance to an exit by applying a voltage across the transport duct.

A simplified, explanatory description of the electron transport mechanism is that electrons impinging on the wall of the transport duct generate secondary electrons. Due to the applied voltage, electrons may impinge on the wall of the electron transport duct, thereby generating the secondary electrons. An electron current is thus formed in the direction of propagation of the electron-transport duct.

The known device comprises an arrangement of at least three plates, comprising a middle plate having apertures, the electrons on their way to the electroluminescent screen selectively passing through the selection apertures in the middle plate and being directed at opposite sides of the middle plate.

For example, an electron current injected into one part of a transport duct, running at one side of the middle plate, can exit said part of the transport duct via two or more apertures, which lead the electron current to an entrance of a further part of the transport duct extending at the opposite side of the middle plate, which part has at the exit side again two or more exit apertures which lead to a further part of a transport duct at the first mentioned side of the middle plate. In this manner a branched network of transport ducts is formed.

In the known device the transport ducts are defined by and in an arrangement of three plates. Subsequent parts of the transport ducts are preferably formed at either side of the middle plate, the connection being formed by the selection apertures in the middle plate. Such a three-plated arrangement has the advantage that a very compact electron transport structure is possible.

However, the inventors have found that the amount of electron current exiting a transport duct at a designated position is generally less than the amount of current injected into a transport duct. This leads to a degradation of the quality of the image produced on the display screen.

### SUMMARY OF THE INVENTION

It is an object of the invention to provide a display device of the type mentioned in the opening paragraph with an improved image rendition.

To this end, the display device is characterized in that an anti-leakage layer is provided for enabling, in operation, an electric potential on a plate of the arrangement, said electric potential counteracting tunneling of electrons between the middle plate and an adjacent plate.

An arrangement with three plates, in which electron ducts alternately run at either side of the middle plate, has as a consequence that during operation an electric potential along the middle plate is formed. The inventors have realized that this electric potential can cause electrons to tunnel in between plates. “Tunneling”, within the concept of the invention, indicates unwanted transport of charge, usually through cracks or slits in between plates.

Electrons can for instance leak to a selection electrode or to a neighboring transport duct. Also, the electric potential may cause field emission, so that electrons are made (for example from an electrode) and find their way to another electrode or transport duct.

Any of these “tunneling” mechanisms has a number of effects. First of all, current is lost, since electrons tunnel in between the plates and are lost. Also, some current will find its way from a part of a transport duct at a certain level to a higher level part of a transport duct, even if this was not the intention. Furthermore, some current will hit the selection electrodes causing a current to run in the selection electrodes and finally, apart from a diminution of the “intended” current and thereby of the current hitting the display screen at the intended position, there are also currents hitting the screen at unintended positions, after having tunneled in between the plates to a transport duct which should have been closed.

The current diminution and related effects are caused by random processes and are thus relatively unpredictable. However, application of anti-leakage layers according to the present invention is an efficient solution for the current diminution problem. Such layers provide an electric potential which, in operation, counteracts the tunneling of the electrons.

In a first embodiment of the invention the anti-leakage layer is formed by a passive anti-leakage layer. Within the concept of the invention “passive anti-leakage layers” are understood to comprise layers which are in operation not connected to a potential source.

In a second embodiment the anti-leakage layer is formed by an active anti-leakage layer, which within the concept of the invention is to be understood to comprise a conductive layer with connections for being connected to a potential source, by which means a potential barrier against tunneling of electrons may be made.

The passive layers of the first embodiment have the advantage that once provided they function without application of any additional electric potentials. Disadvantages of such passive layers are formed by the fact that they are based on some charge-up effect, which will take some time to build up, and inherent conductivity of materials will cause some leaking away of the accumulated charges, which will cause a (usually very) small leaking effect. Also the “stopping power” of the passive anti-leakage layers is set and given once they are applied, there is little flexibility.

The active layers of the second embodiment has the advantage that a flexible barrier can be made that is able to prevent leakage currents more efficiently. However, the active layers require the application of an electric potential.

Within the concept of the invention a single device may comprise both types of layers.

### BRIEF DESCRIPTION OF THE DRAWINGS

These and further aspects of the invention will be described in greater detail, by way of example, and with reference to the accompanying drawings, in which:

FIG. 1 shows a display device in accordance with the present state of the art;

FIGS. 2A and 2B show schematically a detail of a display device of FIG. 1;

FIG. 3 shows an arrangement of three plates as known from the device shown in FIG. 1;

FIGS. 4A to 4C schematically show an arrangement of three plates illustrating the basic principle of the invention;

FIGS. 5A to 5E illustrate a first embodiment of a display device according to the invention and

FIGS. 6A to 6E illustrate a second embodiment of a display device according to the invention.

The drawings are schematic and generally not drawn to scale, and like reference numerals generally refer to like parts.

### DETAILED DESCRIPTION OF THE PREFERRED EMBODIMENTS

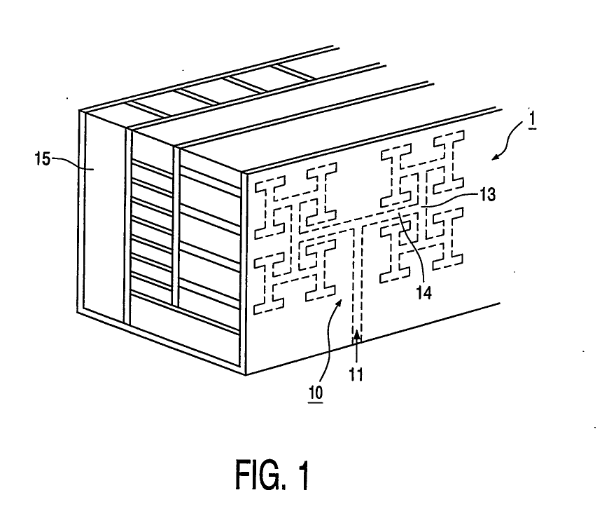

FIG. 1 shows a display device 1 in accordance with the present state of the art.

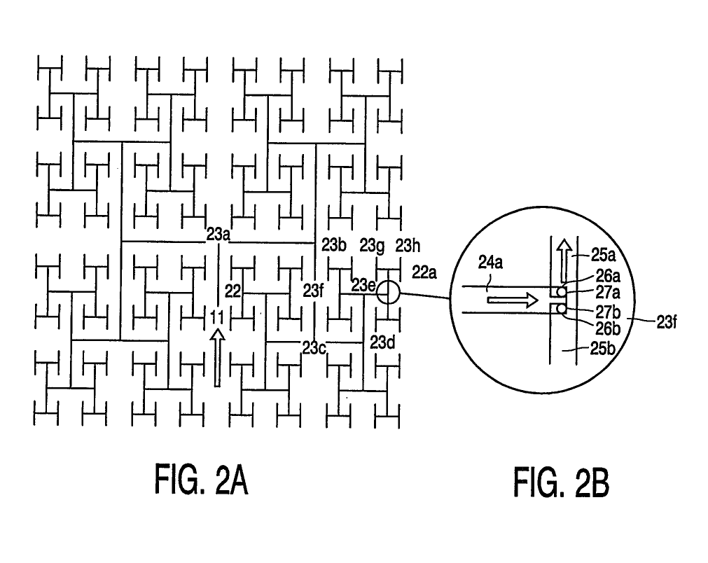

The Figure corresponds to FIG. 2 of U.S. Pat. No. 5,781,166 to which reference is also made for further details. The contents of U.S. Pat. No. 5,781,166 are hereby incorporated by reference. The display device comprises a network 10 of transport ducts (here within also called “electron ducts”) which branches at a point 13. An electron current which is introduced into the network 10, in this case at point 11, is subsequently directed towards the exits 12 via a large number of electron junctions 13 (hereinafter also referred to as “current junctions”) interconnected by transport ducts 14.

At each of said electron junctions 13, the electron current is led, in this example, in one of two directions. The current junctions can be regarded as the nodes of the network 10. In this example, the exits form a two or three-dimensional array and the nodes of the network also form a two or three-dimensional array. If the projection of the electron currents on a plane parallel to the display screen is considered, then the electron current distribution is two-dimensional. When the electrons have exited the exits 12 they are directed to a display screen 15. The display device itself in contained in, or comprised in an evacuated envelope.

FIG. 2A is a top view of the branched network 10. The electron current travels from the entrance 21 to exits 22, for example exit 12a, via eight current junctions 23a to 23h. The exits 22 form a two-dimensional array, as do the current junctions. FIG. 2B is a more detailed view of a current junction (in this example 23f). Each current junction or node in the network comprises, in this example, an electron-supply duct 24a and two electron-exhaust ducts 25a and 25b, apertures 26a and 26b forming the connections between the supply and exhaust ducts and control electrodes 27a and 27b which can be energized so as to selectively guide the electrons into one of the two exhaust ducts 25a or 25b via the connecting apertures 26a or 26b, respectively. Viewed from the entrance 11, the bias on the electrodes increases in the direction of the exits 22.

For example, the voltage on the electrodes in front of the current junction 23a is several tens to several hundreds of volts higher than the voltage in front of the entrance 11, the voltage on the electrodes in front of the current junction 23b is several tens to several hundreds of volts higher than the voltage on the electrodes in front of current junction 23a, etc., etc. This results in an electric field being applied across the transport ducts between the current junctions, said field ensuring that electrons entering via the entrance travel through the network. The electron current is controlled by applying a voltage higher than the normal bias voltage to one of the electrodes, a voltage lower than the bias voltage preferably being applied to the other electrode. As a result, the electrons are led into the exhaust duct associated with said one electrode. Calculating from the entrance 21, a number can be assigned to a node or current junction 23 in the network, which corresponds to the number of current junctions between the relevant current junction and the entrance plus one. In FIG. 2A, the current junction 23a is a current junction of the first order, current junction 23b is a current junction of the second order, current junction 23f is a current junction of the sixth order. Preferably, electrodes of current junctions of equal order are interconnected. By virtue thereof, the number of electrical connections is reduced. In this example, electrodes associated with current junctions of equal order are interconnected. The electrodes of current junction 23f are, for example, connected to electrodes of current junction 23f′. In FIG. 2A, the path along which a current entering via entrance 21 is guided to exit 22a via the network is represented by a thick line. The overall number of exits is formed by an array of 16 times 16=256 pixels. One control electrode is required to control the intensity of the electron current which is injected into the network via the entrance 21, and sixteen electrodes are required to drive this array. The total number of control electrodes is 17. The same array of pixels in the known display device comprises 32 control electrodes (i.e. 16+16). For an array of 2ⁿ pixels, the known display device needs n+m control electrodes, wherein n*m=2ⁿ, i.e. it is at least 2*2^{n/2}, whereas the display device as shown in FIGS. 1 and 2A, 2B comprises (2n+1) control electrodes. Consequently, the number of control electrodes is small. By virtue thereof, the display device is relatively simple. FIGS. 1 and 2A, 2B show an embodiment in which the distance from the entrance aperture to the corresponding exit aperture, through the network, is substantially the same for each of the exit apertures.

The network is simple if the number of exits is equal to n^{m}, wherein n is an integer greater than 1 and m is an integer greater than 1. A network can then be used having m nodes between the entrance and every exit, each node comprising a supply duct and n exhaust ducts. In the examples n is chosen to be two, but obviously, nodes having more than two exhaust ducts fall within the scope of the invention. Two exhaust ducts per node has the advantage that the network can be driven by means of binary codes (a binary code can be assigned to each pixel) and that the nodes are simple too.

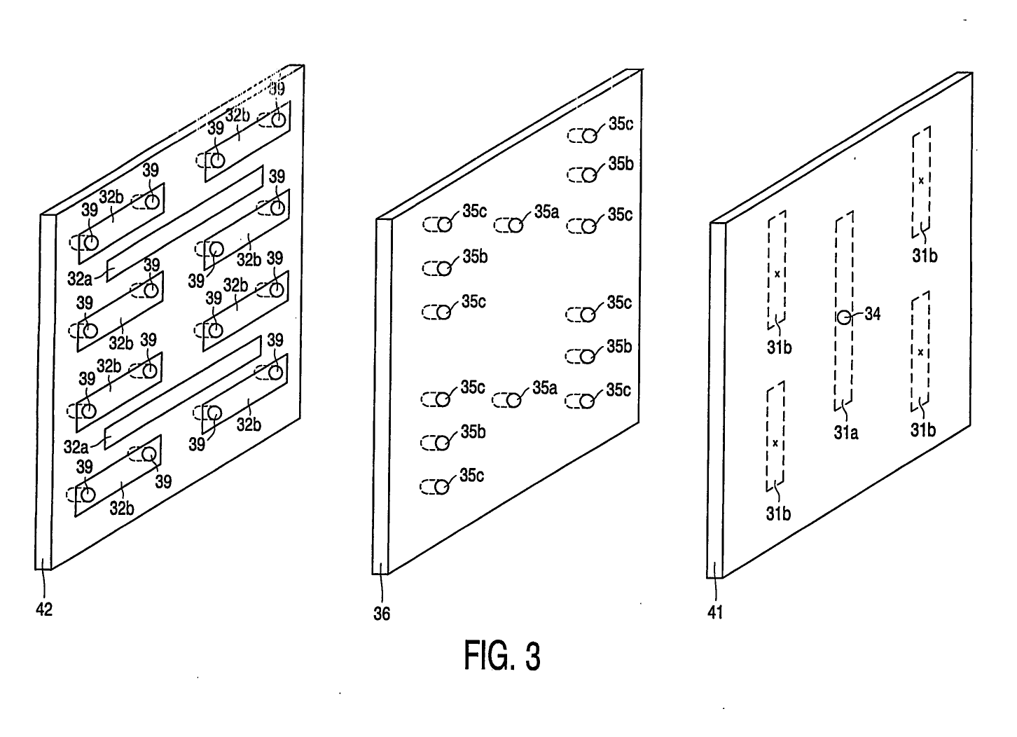

FIG. 3 shows some details of a preferred embodiment of a display device in accordance with the invention. FIG. 3 shows a transport duct being formed by three plates 36, 41, 42. The middle plate 36 is arranged between upper (or lower) plate 41 and lower (or upper) plate 42. A branched network is formed by transport ducts 31a,b in upper plate 41 and transport ducts 32a,b in lower plate 42.

In operation, electrons enter the branched network through an aperture 34 in the upper plate 41. By suitable application of the electric field, the electrons move in either direction through transport duct 31a, and are drawn through one of the apertures 35a in the middle plate 36, towards the lower plate 42. Arriving at the lower plate 42, they continue in either direction through one of the transport ducts 32a.

The electron transport continues in the same manner, so that the electrons successively pass an aperture 35b in the middle plate 36, are guided through a transport duct 31b, pass an aperture 35c in the middle plate 36 and are guided through a transport duct 41b. From a transport duct 41b, the electrons pass through an exit aperture 39 in the lower plate 42 and are then accelerated towards a display screen (not shown).

The apertures 35a, 35b, 35c in the middle plate 36 are surrounded by electrodes (not shown in this Figure).

The configuration shown in FIG. 3 is especially suitable for guiding an electron beam towards one of a tile of picture elements of the display screen. In a preferred embodiment of the invention, the picture elements on the display screen are thus grouped into, for example, 4×4 or 8×8 tiles. For each tile, an electron beam is generated passing into a corresponding branched network for guiding said electron beam towards any picture element of the respective tile.

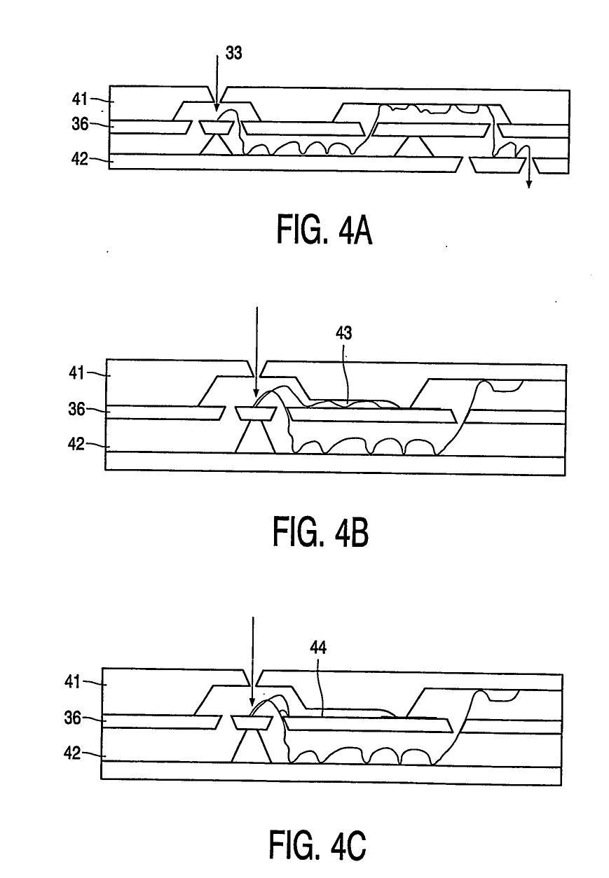

FIGS. 4A to 4C schematically show an arrangement of three plates, a middle plate 36 in between plates 41 and 42, illustrating the basic principle of the invention. FIG. 4A shows the “ideal” situation: An electron current 33 is injected through an aperture in a plate (this could be an aperture in any of the plates 36, 41 or 42), said plates 41 and 42 have apertures provided with electrodes for providing electrical potentials. The electron current “hops” along the transport ducts formed in and in between the plates 36, 41 and 42, from an input aperture to an output aperture, being selectively guided through selection apertures between the input and output aperture. The input current equals the output current, and for non-selected output apertures the output current is zero. This is the ideal situation.

The inventors have, however, found that this is not always the case. The input current does not always equal the output current, and non-selected output apertures may show a residual current. This leads to a degradation of the image on the display screen.

It is an object of the invention to improve the image.

FIG. 4B shows that gaps 43 may be formed in between the middle plate 36 and plate 41 and/or 42. The inventors have realized that an arrangement with three plates, in which electron ducts alternately run at either side of the middle plate, has as a consequence that over the middle plate a potential along the plate is formed. When a gap or slit in between the plates is present, this may cause electrons to tunnel in between plates, as is schematically shown in FIG. 4B. “Tunneling”, within the concept of the invention, indicates unwanted transport of charge through cracks or slits in between plates.

Electrons can for instance leak to an electrode or to a neighboring transport duct. Even by means of field emission (e.g. from an electrode) electrons may be emitted and find their way to another electrode or transport duct. This tunneling has a number of effects, first of all current is lost, since electrons tunnel in between the plates and are lost. Further, some current may find its way from a part of a transport duct at a certain level to a higher level part of a transport duct, even if this was not the intention. Also, some current may hit the selection electrodes causing a current to run in the selection electrodes.

Finally, apart from a diminution of the “intended” current and thereby of the current hitting the display screen at the intended position, there are also currents hitting the screen at unintended positions, after having tunneled in between the plates to a duct which should have been closed. The diminution and related effects are caused by random processes and thus are relatively unpredictable, which makes countermeasures difficult.

Measurements on, in this case, three plate arrangements showed that a leakage current can indeed occur from a first selection chamber or transport duct to the metal tracks of a second, higher order selection chamber or transport duct. This can occur because the second, higher order, selection electrodes need to be at a higher voltage in order to pull the electrons through the selection apertures. However, if a small opening is present between the glass plates then the electrons can take a “short-cut” as indicated in FIG. 4B. This means that a part of the current is “lost” in transit, which is an unwanted effect.

The basic concept of the invention is shown schematically in FIG. 4C: the provision of an anti-leakage layer 44 on either the middle 36 or the adjacent plates 41 and/or 42 for providing in operation a tunneling-counteracting potential on a plate of the arrangement to prevent tunneling of electrons through gaps between the middle plate and an adjacent plate from one transport duct to another.

In one embodiment the anti-leakage layer(s) is (are) passive layers. By passive layers are meant layers that, in operation, obtain a tunneling-counteracting potential in a passive manner. At facing sides the plates 36, 41 and 42 may be covered with a non-conductive, low secondary emission (low δ, i.e. lower than 1) coating, at such position where no hopping transport should take place. A low secondary emission layer will, when hit by electrons, quickly acquires a negative electric charge, thus building a tunneling counteracting potential. This will prevent hopping transport of electrons.

An alternative solution is to cover at least some of the selection electrodes with an insulating material, e.g. frit, SiO2, SiN, etc. This will prevent the electrons from reaching the metal tracks, causing the insulator to charge and a repulsive, thus tunneling counteracting, potential to build up, hence preventing a leakage current. One or both such layers will prevent tunneling in a passive manner, i.e. the potential will build up “automatically”, with no extra measures required.

The difficulty with the “passive layer” solutions it that the electrodes in and around the selection apertures should not be covered with an insulator, or else they will charge up as well, inhibiting the very function of the selection electrodes. Thus this will need another lithography, shadow evaporation or printing step.

In another embodiment of the invention the anti-leakage layer is formed by an active anti-leakage layer, meaning a conductive layer with connections for being connected to a potential source, by which means a potential barrier against tunneling of electrons may be made.

In such embodiment the leakage current is prevented by conductive layers, which could be called “guard electrodes”. These guard electrodes are, in operation, connected to one or more potential sources providing to the guard electrodes a potential lower than the potential of the last selection electrode. Any electrons straying away from their course are then driven back, by the guard potential applied to the guard electrode, back to the intended course. This will require at least one extra metal track, and means for providing an electric potential.

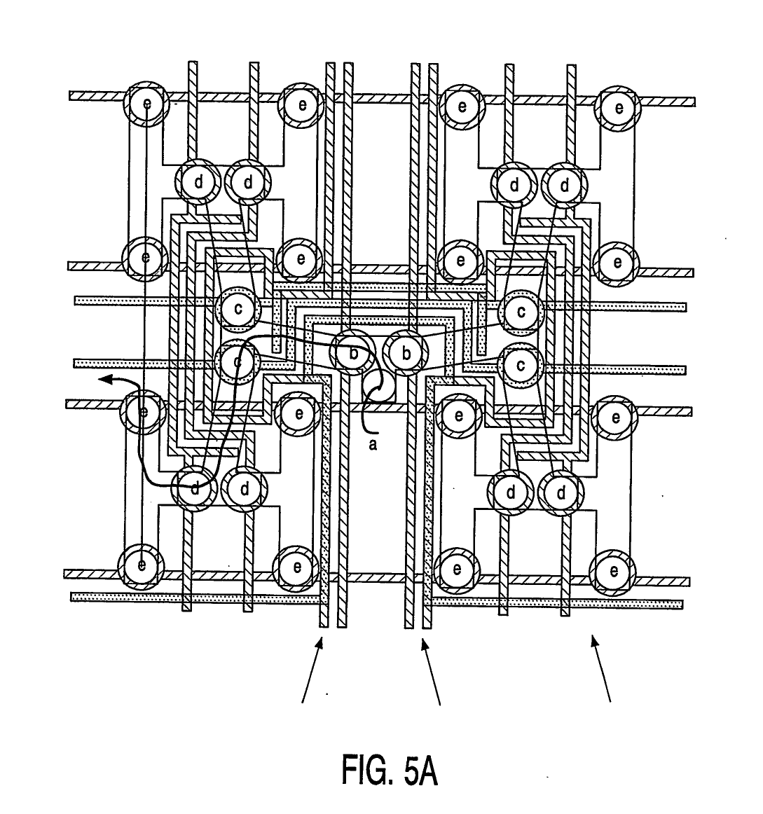

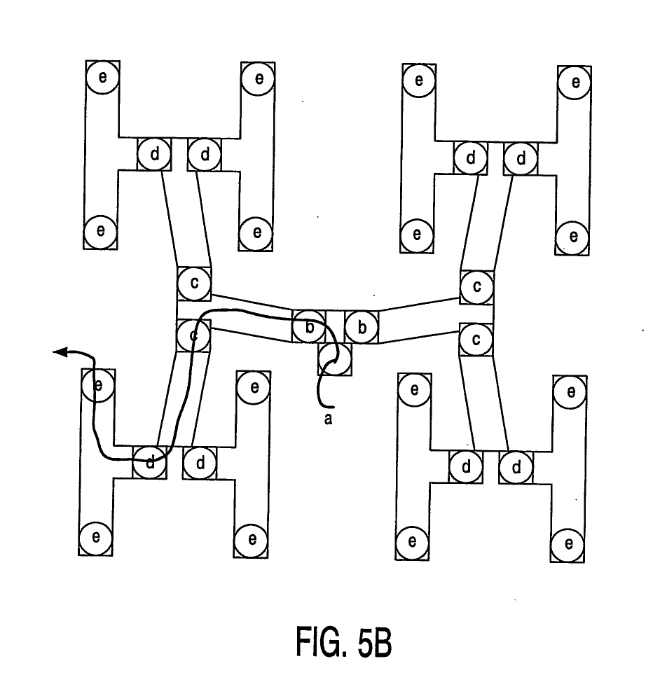

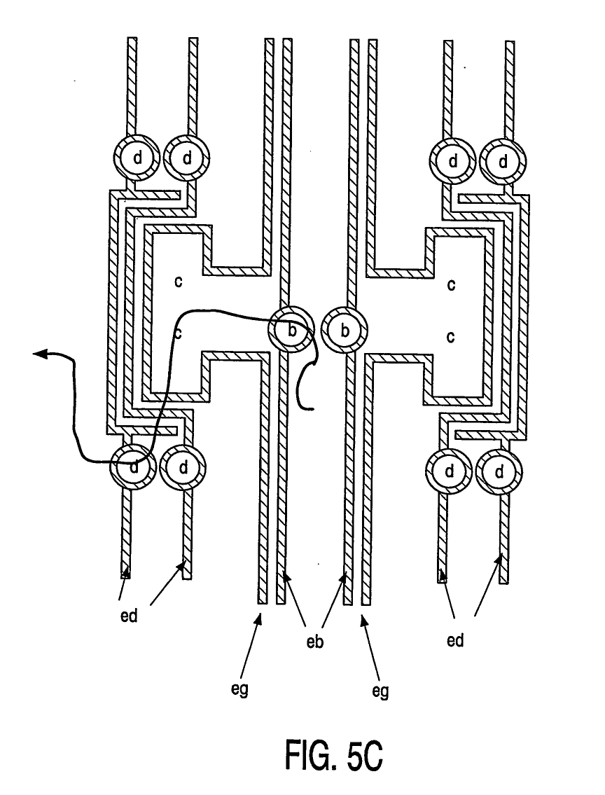

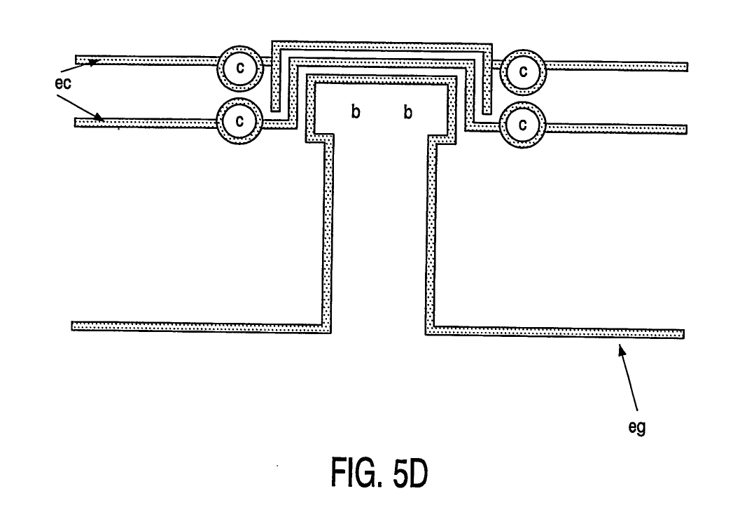

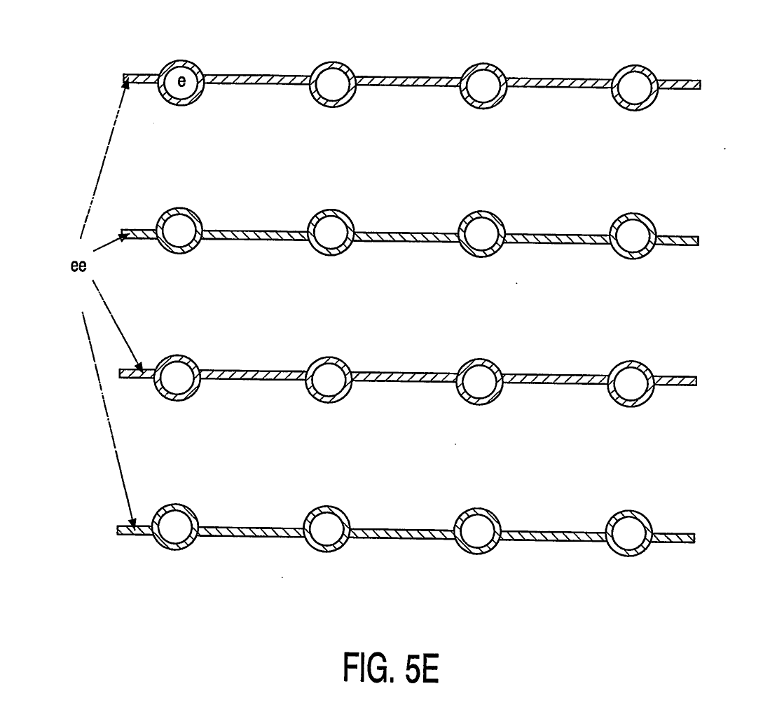

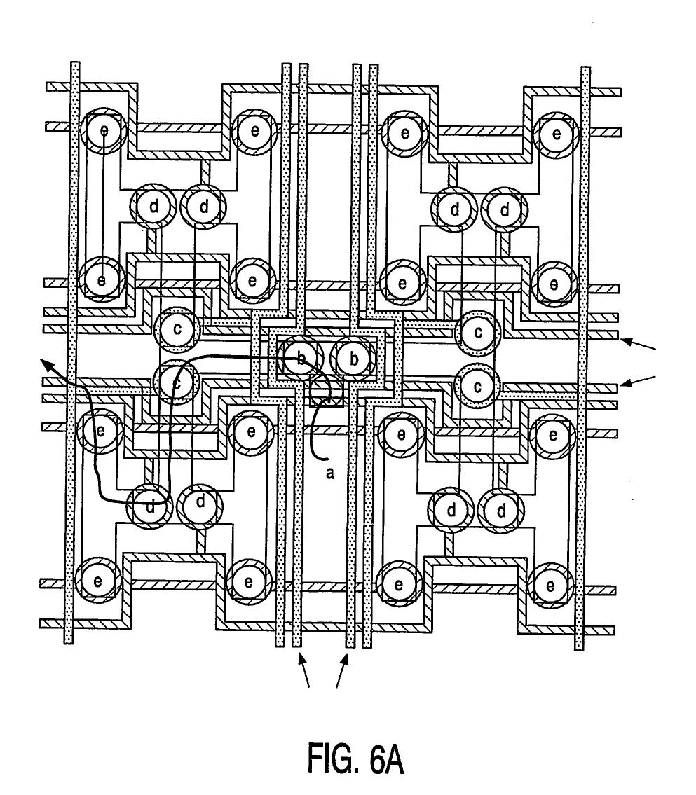

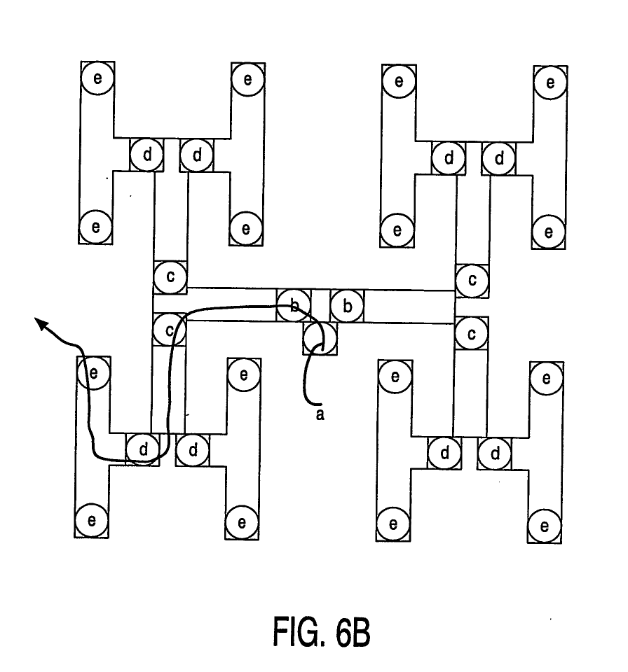

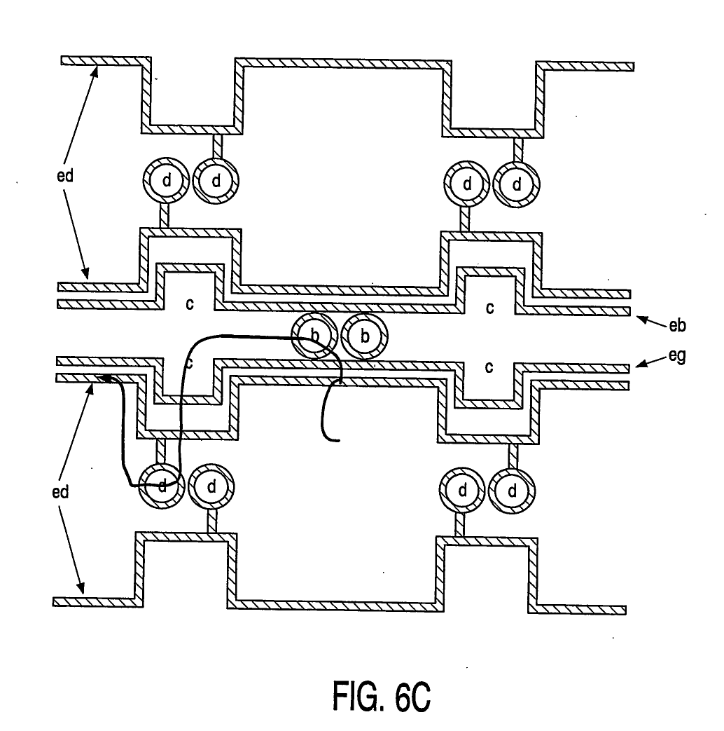

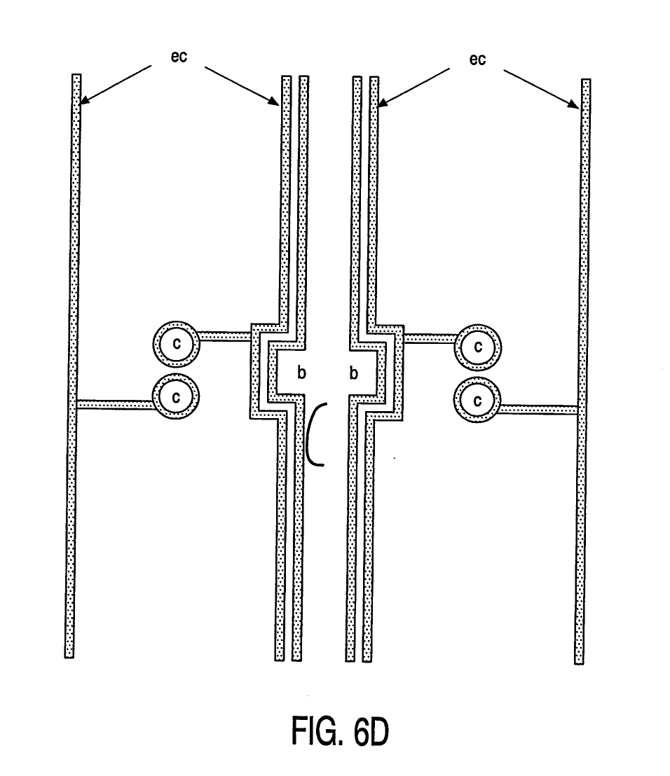

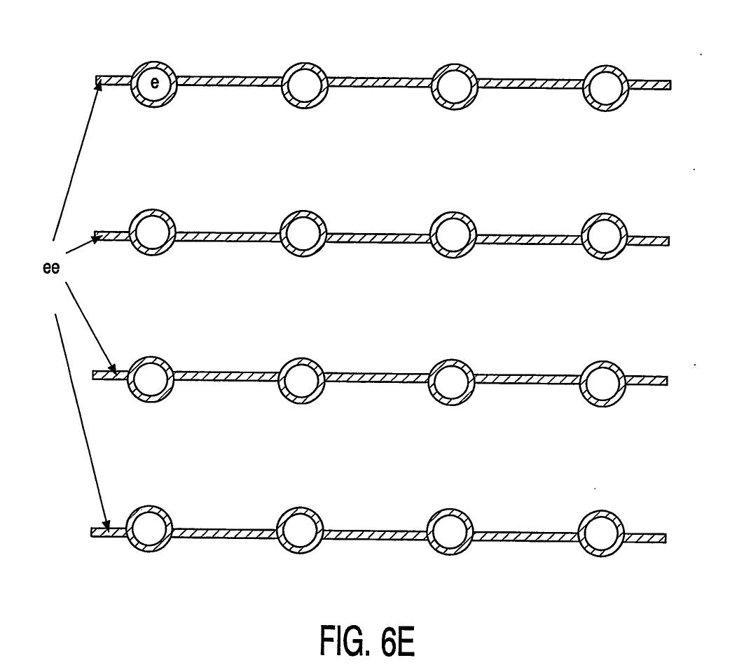

FIGS. 5A to 5E and 6A to 6E show two embodiments of the invention in which guard electrodes (eg) are used. The guard electrodes form a structured anti-leakage layer. The Figures are arranged as follows:

FIGS. 5A and 6A show a planar view of all transport ducts, selection chamber, selection electrodes and guard electrodes. In these Figures sequential selection apertures are denoted by a, b, c, d and e. a is the first (entrance) aperture, e is the final (exit) aperture. One possible selection path through a sequence of apertures a to e is schematically shown by means of an arrow. The guard electrodes are indicated by arrows. Although FIGS. 5A and 6A show all details in their mutual positions, these Figures are also quite complicated, so FIGS. 5C to 5E and 6B to 6E are drawn to show details.

FIGS. 5C and 6B show the arrangement of the transport duct, selection chambers and selection apertures a to e; in these Figures the possible selection path is also shown. An electron stream enters through aperture a, is then directed through selection apertures b by applying suitable potentials to selection electrodes eb (see FIGS. 5C, 6C) either to the left or to the right (in the shown path to the left), is transported through a transport duct to a next selection stage c (comprising two selection apertures c), is directed (by applying suitable potentials to selection electrodes ec (see FIGS. 5D, 6D) surrounding the selection apertures c) up or down (in the downward path shown), is transported through a transport duct to a next selection stage d, is then directed through selection apertures d by applying suitable potentials to selection electrodes ed (see FIGS. 5C, 6C) either to the left or to the right (in the shown path to the left), and is finally directed, by applying suitable potentials, to electrodes ee (see FIGS. 5E and 6E) to an exit aperture e.

FIGS. 5C and 6C show the arrangement of the selection electrodes eb (for selection apertures b) and ed (for selection electrodes d). These selection electrodes are provided on one side of one plate. FIG. 5C shows that, apart from the selection electrodes eb and ed, a further set of electrode eg is provided on the same surface. These form the guard electrodes, when applied with a potential lower than the potential of electrodes d, these guard electrodes form a potential barrier for electrons in a selection chamber comprising the selection apertures c, from “hopping along” the surface to the electrodes d. Unwanted leakage of electrons through gaps in between the plates from one selection stage (stage c) to the next (stage d) is thereby prevented.

In FIG. 6C the b-electrodes eb are arranged in such manner that they themselves function as guard electrodes. In this embodiment therefore the electrodes from a first selection stage (b) act as the guard electrodes for a second selection stage (c). This decreases the number of voltages that need to be applied, but switching the first selection has a larger effect on the hopping of the electrons from the first selection to the second selection. This is an example of a preferred embodiment of the invention in which the electrodes are arranged such that they have a double function, forming selection electrodes near one or more apertures, and anti-leakage layers (guard electrodes) at another or other positions. This reduces the number of connections, voltages and electrodes needed.

FIGS. 5D and 6D show the selection electrode ec for the c-selection apertures. They are arranged on a surface of a plate different from the surface in which the b and d electrodes (FIG. 5C, 6C) are arranged. In these Figures guard electrodes eg are also shown, they prevent unwanted leakage of electrons from stage b to stage c.

Finally FIGS. 5E and 6E show the exit selection electrodes ee, which are arranged in one plane near the exit side of the exit electrodes which is a plane different from the plane for the electrode eb and ed, and the plane for the electrodes ec.

Of course it may be advantageous to combine the solutions of the different embodiments. This is in particular the case if the selection electrodes act as field emitters, because the guard electrode will not or only partially prevent electrons from hopping between one selection electrode and the next once they have been emitted by such a field emitter.

In the embodiments described, the network is two-dimensional, the exits form a two-dimensional array and the nodes of the network also form a two-dimensional array. The term two-dimensional is to be understood to mean herein that, viewed in projection on the display screen, the current distribution is two-dimensional. A network according to the above shown embodiments of the invention could be described as being a two-dimensional current distributor, having electron ducts, interconnected at nodes, which nodes form junctions of at least one entrance and at least two exhaust ducts, whereby at each node, an electron current coming in through the entrance duct can, by means of apertures connecting the entrance and exhaust ducts, be steered into a desired exhaust duct.

In the examples shown above, the electron currents move, apart from the feedthroughs between the transport ducts, in the transport ducts in the horizontal and/or vertical direction. The invention is not limited thereto. The network can be three-dimensional and comprise transport ducts in three or more directions. In the examples, the image displayed is two-dimensional. The invention is not limited thereto, the image displayed can be three-dimensional, for example, it can be displayed on the sides of a cube. It is alternatively possible to display the image on the surface of a hemisphere, the network being constructed so as to form a number of hemispheres which are stacked on top of each other, and each hemisphere comprising transport ducts.

The wording in the claim that “a” or “an” element is present includes the possibility that a plurality of such elements is present. For instance, the display device may comprise a single branched network that distributes electrons from the electron source over the entire display screen. However, preferably the number of branched networks is larger than one, whereby a branched network distributes electrons over an associated portion of the display screen. Each branched network has its own entrance and a corresponding electron source.

In summary, a display device (1) comprises a luminescent display screen (15), and means for directing electrons towards the display screen (15). Said means comprise an arrangement of at least three plates (36, 41, 42), with a middle plate (36) having selection apertures, and selection electrodes associated with the selection apertures. The selection apertures, the selection electrodes and the plates are arranged for having the electron currents, on their way from a source to the electroluminescent screen, selectively pass the apertures in the middle plate and alternately run at opposite sides of the middle plate. An anti-leakage layer (44, eg) for providing, in operation, a tunneling counteracting potential is provided on a plate of the arrangement to prevent leakage of electrons through gaps between the middle plate and an adjacent plate.

1. A display device (1) comprising:
a vacuum envelope, an inner side of which is provided with a luminescent display screen (15), said vacuum envelope comprising at least
an electron source (31) for emitting electrons and
directing means for directing the electrons towards said display screen (15),
said directing means comprising:
an arrangement of at least three plates (36, 41, 42) defining a network (10) of electron transport ducts, a middle plate (36) of the arrangement being provided with selection apertures and
selection electrodes associated with the selection apertures for application of selection voltages,
said directing means being arranged for selectively passing the electrons through the selection apertures and directing the electrons alternately at opposite sides of the middle plate,
characterized in that an anti-leakage layer (44, eg) is provided for enabling, in operation, an electric potential on a plate of the arrangement, said electric potential counteracting tunneling of electrons between the middle plate and an adjacent plate.

2. A display device as claimed in claim 1, characterized in that the anti-leakage layer is formed by a passive anti-leakage layer.

3. A display device as claimed in claim 2, characterized in that facing sides of the plates (36, 41 and 42) are provided with a non-conductive coating having a secondary electron emission coefficient smaller than 1, at positions where no electron transport should take place.

4. A display device as claimed in claim 2, characterized in that at least some of the selection electrodes are at least partly covered with an insulating material.

5. A display device as claimed in claim 4, characterized in that all selection electrodes are at least partly covered with the insulating material.

6. A display device as claimed in claim 1, characterized in that the anti-leakage layer is formed by an active anti-leakage layer (eg).

7. A display device as claimed in claim 6, characterized in that at least some of the selection electrodes are arranged for functioning as the anti-leakage layer.
